(19) United States
(12) Patent Application Publication
(10) Pub. No.: US 2013/0162070 A1
(43) Pub. Date: Jun. 27, 2013

(54) AC LOW-VOLTAGE INDUCTION MOTOR

(71) Applicants: HUAN-CHING TSENG, Chiayi County (TW); Chiun-Liang Tsai, Chiayi (TW); Chun-Hsin Tsai, Chiayi (TW)

(72) Inventors: HUAN-CHING TSENG, Chiayi County (TW); Chiun-Liang Tsai, Chiayi (TW); Chun-Hsin Tsai, Chiayi (TW)

(21) Appl. No.: 13/333,644

(22) Filed: Dec. 21, 2011

(51) Int. Cl. H02K 9/06

(52) U.S. Cl. 310/62

(57) ABSTRACT

An AC low-voltage induction motor contains a rotor having a central shaft; a stator having a plurality of silicon steel pieces and a number of coil sets, each silicon steel piece having a groove to receive the coil set; a number of supports inserted into four corners of a front cover and four corners of a rear cover to connect the rotor, the stator, and a fan together; wherein a diameter and a number of the coil set is capable of determining a supply amount of a working voltage.

### BACKGROUND OF THE INVENTION

1. Field of the Invention

The present invention relates to an AC low-voltage induction motor that is capable of obtaining safety, low electricity assumption, and energy saving and carbon reduction.

2. Description of the Prior Art

A use voltage of a conventional AC motor is 110 volt or 220 volt, but a rotating speed of the conventional AC motor is fixed by a power frequency, so the conventional AC motor can not operate at a high speed and at an AC frequency, and a highest speed of the conventional AC motor is 3600 rpm. In addition, the conventional AC motor causes electricity leak and high voltage electrical fire. If a working voltage is below 55 volt, a transformer rectifier has to be provided with the conventional AC motor, however the conventional AC motor still has the following defects:

1. high electricity consumption;

2. easy temperature raise;

3. complicated structure and high production cost;

4. short service life.

The present invention has arisen to mitigate and/or obviate the afore-described disadvantages.

### SUMMARY OF THE INVENTION

The primary object of the present invention is to provide an AC low-voltage induction motor that is capable of overcoming the shortcomings of the conventional AC low-voltage induction motor.

Further object of the present invention is to provide an AC low-voltage (below 55 volt) induction motor that is capable of obtaining safety, low electricity assumption, and energy saving and carbon reduction.

Another object of the present invention is to provide an AC low-voltage induction motor that is capable of obtaining lower temperature and prolonging service life.

To obtain the above objectives, an AC low-voltage induction motor contains

a rotor having a central shaft;

a stator having a plurality of silicon steel pieces and a number of coil sets, each silicon steel piece having a groove to receive the coil set;

a number of supports inserted into four corners of a front cover and four corners of a rear cover to connect the rotor, the stator, and a fan together;

wherein a diameter and a number of the coil set is capable of determining a supply amount of a working voltage.

### BRIEF DESCRIPTION OF THE DRAWINGS

FIG. 1 is a perspective view showing the exploded components of an AC low-voltage induction motor according to a preferred embodiment of present invention;

FIG. 2 is a perspective view showing the assembly of the AC low-voltage induction motor according to the preferred embodiment of present invention;

FIG. 3 is a cross sectional view showing the assembly of the AC low-voltage induction motor according to the preferred embodiment of present invention;

FIG. 4 is another cross sectional view showing the assembly of the AC low-voltage induction motor according to the preferred embodiment of present invention;

FIG. 5 is a block diagram showing the operation of the AC low-voltage induction motor according to the preferred embodiment of present invention;

FIG. 6 is a block diagram showing the operation of the AC low-voltage induction motor according to another preferred embodiment of present invention;

FIG. 7 is a block diagram showing the operation of the AC low-voltage induction motor according to another preferred embodiment of present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

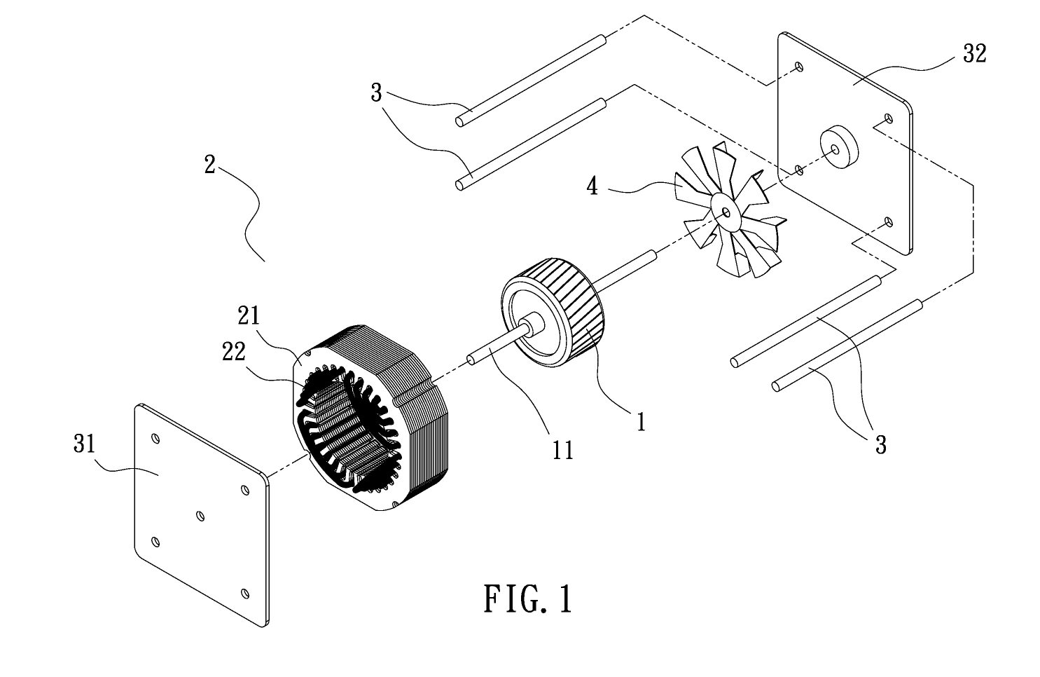

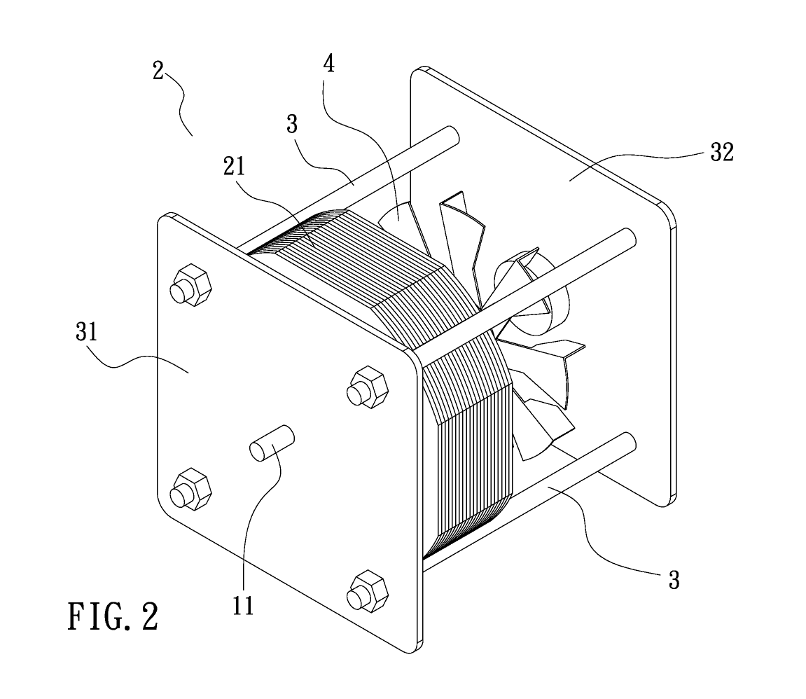

With reference to FIGS. 1 and 2, an AC low-voltage induction motor 7 according to a preferred embodiment of the present invention comprises:

a rotor 1 having a central shaft 11;

a stator 2 having a plurality of silicon steel pieces 21 and a number of coil sets 22, each silicon steel piece 21 having a groove;

a number of supports 3 inserted into four corners of a front cover 31 and four corners of a rear cover 32 to connect the rotor 1, the stator 2, and a fan 4 together.

The rotor 1 is fixed in the stator 2 to rotate freely, the central shaft 11 is inserted through the front cover 31 and the rear cover 32 to drive the AC low-voltage induction motor 7 to rotate.

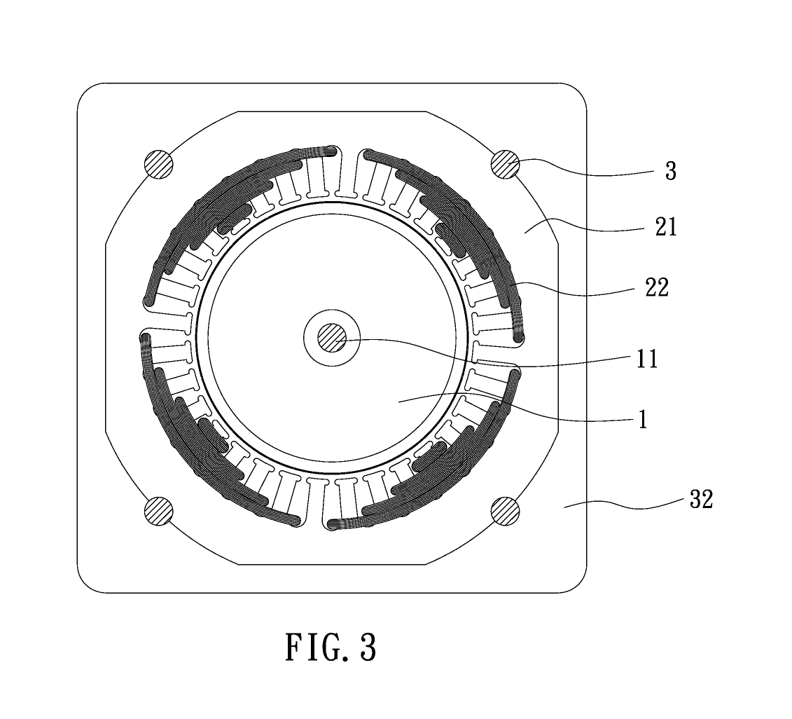

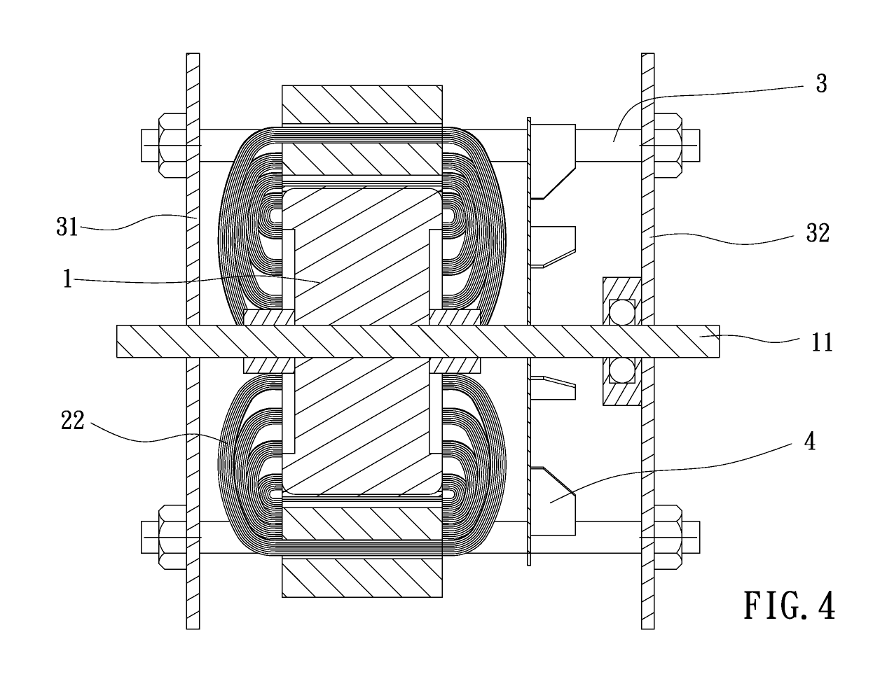

Referring to FIGS. 3 and 4, the stator 2 is defined between the front cover 31 and the rear cover 32, and the front cover 31 and the rear cover 32 are positioned by using the number of supports 3, the plurality of silicon steel pieces 21 of the stator 2 are shown in a cross sectional view of FIG. 3, and each coil set 22 is mounted in the groove of the silicon steel pieces 21.

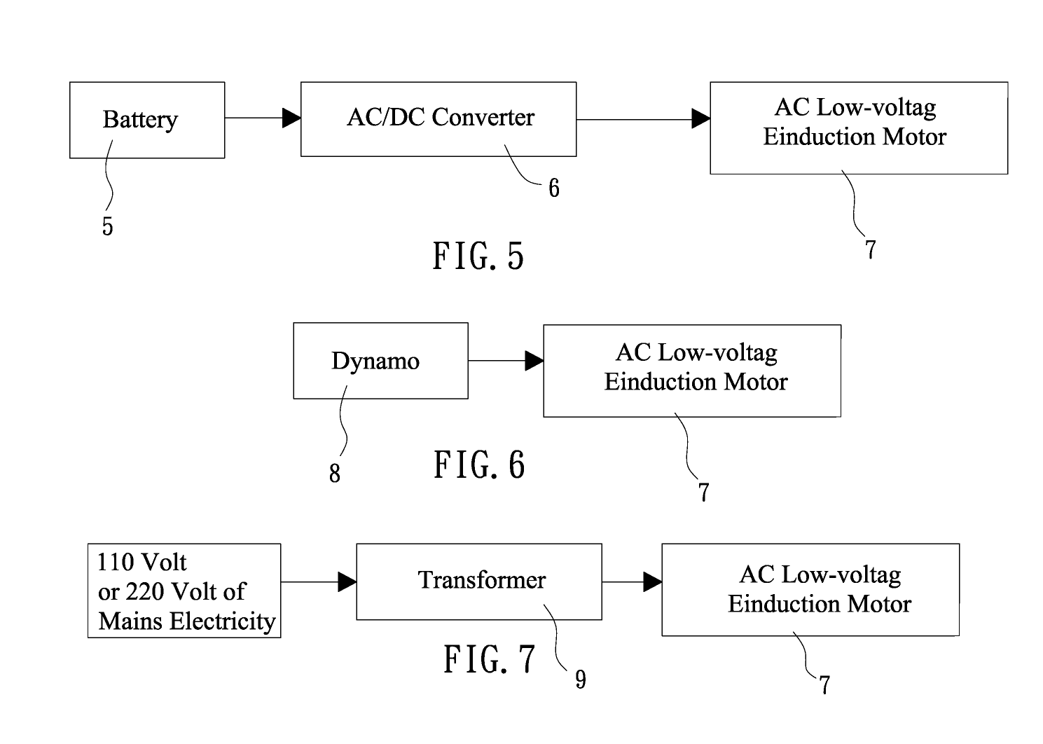

In operation of the AC low-voltage induction motor 7, if a battery 5 to store electricity is cooperated with the AC low-voltage induction motor 7, an AC/DC converter 6 is provided with the AC low-voltage induction motor 7 as shown in FIG. 5; if a dynamo 8 is used to drive the AC low-voltage induction motor 7, a working voltage is transformed and supplied toward the AC low-voltage induction motor 7 as illustrated in FIG. 6; as shown in FIG. 7, 110 volt or 220 volt of mains electricity is supplied and transformed into a working voltage of the AC low-voltage induction motor 7 by a transformer 9.

While we have shown and described various embodiments in accordance with the present invention, it is clear to those skilled in the art that further embodiments may be made without departing from the scope of the present invention.

What is claimed is:

1. An AC low-voltage induction motor comprising a rotor having a central shaft;
a stator having a plurality of silicon steel pieces and a number of coil sets, each silicon steel piece having a groove to receive the coil set;
a number of supports inserted into four corners of a front cover and four corners of a rear cover to connect the rotor, the stator, and a fan together.

2. The AC low-voltage induction motor as claimed in claim 1, wherein a diameter and a number of the coil set is capable of determining a supply amount of a working voltage.
